(19) United States
(12) Patent Application Publication
(10) Pub. No.: US 2012/0197814 A1
(43) Pub. Date: Aug. 2, 2012

(54) CONTENT ENDORSEMENT

(76) Inventor: Hsin Lin, Cambridge, MA (US)

(21) Appl. No.: 13/015,005

(22) Filed: Jan. 27, 2011

(51) Int. Cl. G06Q 30/00

(52) U.S. Cl. 705/319

(57) ABSTRACT

A computer-implemented method for content endorsement includes receiving, at a server, postings from posters; receiving, for each posting, a posting fee; receiving endorsements drawn by the postings; receiving, for each endorsement, an endorsement fee; collecting the endorsement fees into a pot; based on the endorsements, defining a subset of postings; and allocating at least a portion of the pot to postings in the subset of postings.

### FIELD OF INVENTION

The invention relates to social networks, and in particular, the solicitation of views from members of social networks.

### BACKGROUND

In a computer-implemented social network, members carry out many of the same functions that one would expect them to carry out at any social function. For example, members will share photographs, stories, interesting quips and tidbits and the like. Among the activities that a computer-implemented social network facilitates is that of a spirited exchange of views on some topic.

Many social networks allow users to post content, and other users to express approval of the posted content. For example, in connection with a particular photograph, users can often click a “like” button or a thumbs-up icon. Endorsement, however, carries little in the way of a tangible reward for the poster.

### SUMMARY

In one aspect of the invention, a computer-implemented method for content endorsement includes receiving, at a server, postings from posters; receiving, for each posting, a posting fee; receiving endorsements drawn by the postings; receiving, for each endorsement, an endorsement fee; collecting the endorsement fees into a pot; based on the endorsements, defining a subset of postings; and allocating at least a portion of the pot to postings in the subset of postings.

Other practices of the foregoing method include those in which allocating at least a portion of the pot includes allocating the entire pot among the postings in the subset, and those in which allocating includes allocating to a posting on the basis of an extent to which the postings drew endorsements, and those in which allocating includes withholding allocation from a posting that drew less than a pre-defined number of endorsements.

Yet other practices include those in which receiving endorsements includes receiving both positive endorsements and negative endorsements. Among these are those in which allocating includes allocating fees to a pot to be distributed to a designated donee organization.

In a number of practices, the fees arise from an endorsement. Among those practices are those in which fees arise from a negative endorsement, and the donee organization is selected by a voter; those in which fees arise from a positive endorsement, and the donee organization is selected by a poster; and those in which fees arise from a tip to a poster, and the donee organization is selected by the poster.

In at least one practice, the method also includes receiving a tip for distribution to a poster.

In another aspect, the invention features a content-endorsement system that includes endorsing servers; posting servers; and a content endorsement server for receiving postings from the posting servers and endorsements from the endorsing servers, collecting endorsement fees and posting fees, and following completion of a voting period, tallying votes associated with each of the postings, and distributing endorsement fees.

In one embodiment of the content-endorsement system the content endorsement server includes a non-transitory computer-readable medium having encoded thereon instructions for receiving, at the content-endorsement server, postings from the posting servers; receiving, for each posting, a posting fee; receiving endorsements drawn by the postings; receiving, for each endorsement, an endorsement fee; collecting the endorsement fees into a pot; based on the endorsements, defining a subset of postings; and allocating at least a portion of the pot to postings in the subset of postings.

In another aspect, the invention features a computer-readable medium having encoded thereon software for implementing content endorsement on a social network, the software including instructions for receiving, at a server, postings from posters; receiving, for each posting, a posting fee; receiving endorsements drawn by the postings; receiving, for each endorsement, an endorsement fee; collecting the endorsement fees into a pot; based on the endorsements, defining a subset of postings; and allocating at least a portion of the pot to postings in the subset of postings.

These and other features of the invention will be apparent from the attached claims and the accompanying figures, in which:

### DESCRIPTION OF THE DRAWINGS

FIG. 1 shows a content endorsement system;

FIG. 2 shows an implementation of a content endorsement system using a wide area network; and

FIG. 3 shows the high-level architecture for implementing the content endorsement system of FIG. 1.

### DETAILED DESCRIPTION

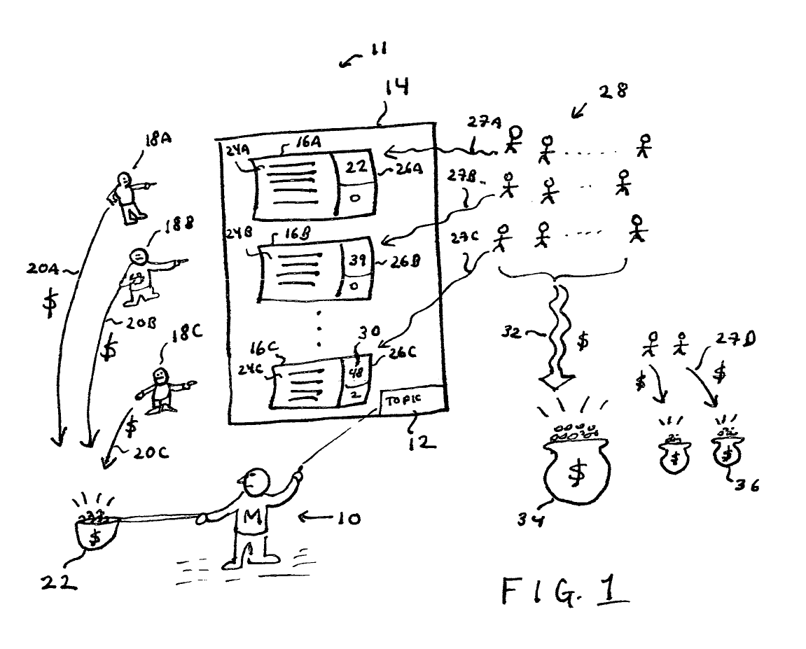

In one implementation of a content endorsement system 11, shown in FIG. 1, a moderator 10 selects a particular issue or topic 12 and causes a social network to display a web page 14 that solicits postings 16A-C concerning that topic 12. Each posting 16A-C has an associated poster 18A-C. However, any poster 18A-C may submit two or more postings 16A-C.

In general, each posting 16A-C advocates a particular point-of-view concerning that topic 12. In the content endorsement system 11 described herein, there are assumed to be two points-of-view. However, there can be any number of such points-of-view, depending on the nature of the topic 12.

Each posting 16A includes content 24A, which is provided by the poster 18A, and an associated endorsement section 26A. In typical cases, the content 24A provided by the poster 18A is a piece of writing, with or without illustration. However, in creating the content 24A, the poster 18A can make use of video, audio, or any other communication medium.

For each posting 16A-C, the content endorsement system 11 collects a posting fee 20A-C from the poster 18A-C. Typically, the posting fee 20A-C is remitted from a suitable internet remittance service to the moderator's account 22. The requirement of a posting fee 20A discourages frivolous postings and encourages higher quality communication. Thus, the posting fee 20A should be set high enough to discourage an undue number of postings 16A but low enough to ensure a reasonable number of postings 16A. An undue number of postings 16A and a reasonable number of postings 16A would both be pre-defined by the moderator 10. In some cases, the posting fee 20A may be dynamically adjusted in response to a rate at which postings 16A occur. In one particular practice, the posting fee 20A is made higher as the time elapses to discourage free riders from sharing in the prize awarded to winning posters 18A-B, as described below.

An endorsement section 26A shows an extent to which a posting 16A has been endorsed by voters 28. For example, an endorsement section 26A might show a number of votes 27A, 27D drawn by that posting 18A from voters 28. These votes can be votes in favor of the posting, i.e. positive votes 27A, or votes against the posting, i.e. negative votes 27D. In some implementations, the endorsement section 26A is hidden to avoid any bias caused by a tendency of a heavily endorsed posting to draw endorsements and vice versa.

In one implementation, an extent of endorsement depends on votes 27A-C cast by voters 28 who indicate support or agreement with one or more postings 16A-C by voting. Each vote 27A-C requires that the voter 28 pay a voting fee 32. The voting fee 32 is placed in a pot 34 for distribution according to one of the pot distribution methods discussed below.

A variety of voting schemes can be used. In some practices, a voter 28 can only vote for one posting, whereas in others, a voter 28 can vote for multiple postings 16A-C, or multiple times for the same posting 16A. In some practices, each vote, however, would be subject to the same voting fee 32. However, in other practices, different votes can be be subject to different voting fees.

At the end of a voting period, the content endorsement system 11 tallies the votes for all postings 16A-C associated with each point-of-view and, on the basis of the resulting vote tally, selects a winning point-of-view. The pot 34 is then distributed among all the postings 16A-B for the winning point-of-view.

At the outset, the moderator 10 opens an issue or topic, and defines a voting period during which votes may be received. This voting period can be defined to end after lapse of a particular time, or after the occurrence of an event, such as the receipt of a certain number of votes, or the participation of a pre-set number of voters and/or posters.

The moderator 10 also defines the procedure for selecting a winning point-of-view. This procedure can depend solely on the votes. However, in some practices, the procedure can depend on the outcome of a real event, such as an election, or an athletic contest.

In one pot distribution method, referred to as a “winner-take-all” method, each posting 16A-C is credited with an amount proportional to a contribution ratio. A contribution ratio for a particular posting 16A is defined by the ratio of the number of votes received by that posting 16A to the number of votes received by the side associated with that posting 16A. In the “winner take all” method, the entire pot is distributed among the postings 16A-B of the winning side. In such a case, the pot 34 is divided among the postings 16A-B on the basis of the contribution ratios for each posting 16A-B. Thus, if the winning side receives K votes, and posting n drew k of those votes, then for a pot P, the poster of posting n will receive a value of (k/K)·P

The above distribution method tends to reward those postings 16A-C that attracted the largest number of votes and therefore presumably awards the poster's skill as a persuasive poster.

In another pot distribution method, referred to as the “winner-take-most” method, most of the pot 34 is divided among the winning side's postings 16A-B, but a portion of the pot 34 is divided among the losing side's postings 16C. A consolation parameter controls the relative amounts of the pot 34 that are available for distribution by the winning side and the losing side.

In the “winner-take-most” pot distribution method, there would be two contribution ratios: a winner's contribution ratio and a loser's contribution ratio. For each posting 16A on the winning side, the winner's contribution ratio for that posting 16A is the number of votes 27A that that posting drew in favor of the winning side and the total number of votes 27A, 27B for the winning side. Similarly, for each posting on the losing side, the loser's contribution ratio for that posting is the number of votes 27C that that posting 16C drew in favor of the losing side.

In one practice, a consolation parameter, α, is a scalar greater than 0 and less than 1. In this case, if a pot 34 has value P and posting n drew k of the K votes for a winning side, and if there were L votes for the losing side, then posting n would receive an amount proportional to (k/K)·P·(K+α·L). Conversely, if posting m drew l of the L votes for the losing side, then posting m would receive an amount proportional to (l/L)·P·(1·α)·L.

For the special case in which α=0, there is no redistribution among the earning of posts. As a result, there is no need to have a finite or pre-defined voting interval. In this case, because the amount credited to a posting 16A does not depend on any future event or condition. Therefore, an amount credited to a posting 16A by a vote 27A can be distributed to the poster 18A as soon as practicable after the vote 27A has occurred.

In a third practice, there exists a vote threshold. If a particular posting 16A on the winning side fails to draw more votes than the vote threshold, then that posting 16A will not receive any share of the pot 34. In that case, the pot 34 is diminished by an amount corresponding to the number of votes drawn by that particular posting 16A, and the remainder of the pot 34 is divided according to one of the foregoing methods.

As used herein, the term “endorsement” connotes support for a position, i.e. “positive endorsement,” and support for the converse of a position, i.e. “negative endorsement.” According to the methods described thus far, a voter 28 can express only a positive endorsement. However, in the practice described below, a voter 28 can express a negative endorsement as well by voting either for or against a particular posting 16C. When allocating a portion of the pot to that posting 16C, negative votes offset positive votes. In such a case, a particular posting 18C may draw more negative votes than positive votes, and actually contribute negative votes to the point-of-view that it supports.

In the case where the vote tally for a winning point-of-view includes negative votes, the distribution of voting fees 32 for each posting 16A proceeds only on the basis of votes supporting the posting voting fee 16A. The voting fee from votes 27D made against a posting would be diverted to a one or more donee organizations 36 specified by the voter 28. Examples of donee organizations include charitable groups and/or fundraising efforts designated by the negative voter. Such a donation is more useful than a conventional donation because not only does the donee 36 receive the revenue, as would occur in a conventional donation, but the voter 28 also makes a public statement concerning the topic 12.

A diversion of voting fees to a donee 36 can be carried out in other ways. For example, in some cases, a portion of a payout from the pot 34 to a winning poster 18A can be diverted to a donee selected by the winning poster 18A. This provides a way to divert, to a donee, fees arising from a positive vote instead of a negative vote.

Another implementation includes a mechanism for enabling a voter 28 to directly tip a poster 18A without actually registering a vote. This mechanism would ensure that the poster 18A receives money without also having to be on the winning side.

The tipping mechanism is independent of voting. As a result, a voter 28 can both tip and vote. Fees earned by a poster 18A through tips, or portions thereof, can also be diverted to a donee chosen by the poster 18A.

A system and method as disclosed herein thus provides a forum through which those versed in the communication arts, such as writers, illustrators, musicians, and videographers, can earn income by appealing directly to the ultimate consumer, and thereby bypassing the middleman in the process.

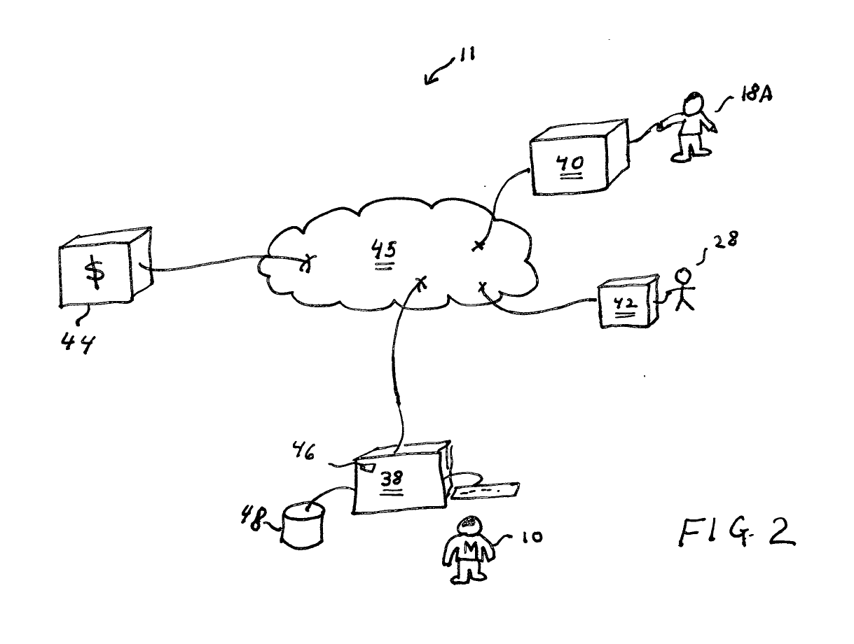

FIG. 2 shows one implementation of the content endorsement system 11 executing on a content endorsement server 38 that is in data communication with posting clients 40, endorsement clients 42, and a payment server 44, all of which are interconnected by a wide area data communication network, such as the internet 45.

In some cases, the posting clients 40 and the endorsement clients 42 may be located within a political jurisdiction that differs from that at which the content endorsement server 38 is located. For example, the content endorsement server 38 may be located within United States territory, but may receive postings 16A and votes 27A from clients 40, 42 located outside United States territory.

In some implementations, software for executing the methods described herein is executed at the content endorsement server 38. However, in other cases, certain functions may be more efficiently executed at the posting client 40 or at the endorsement client 42, in which case the content endorsement server 38 can transmit client-side software to the appropriate client 40, 42 for local execution.

A typical content endorsement server 38 includes a processor in data communication with a non-transitory and tangible computer-readable storage medium 48 of the type that would qualify as a manufacture within the meaning of 35 USC 101 as of the filing date of this application. The computer-readable storage medium 48 has encoded thereon, in tangible form, instructions that when executed by processor 46 cause the processor 46 to execute the methods described herein.

Both the processor 46 and the computer-readable storage medium 48 consist of matter. At each instruction, tangible and measurable charge is moved throughout the matter that makes up processor 46 and medium 48. Accordingly, execution of the instructions stored in medium 48 will result in transformation of matter. The methods described herein are likewise tied to a particular machine, namely the content endorsement server 38.

The content endorsement server 38 is typically a general purpose computer that has been specially programmed to carry out the methods recited herein, and as such has become a new machine that differs in capability from a general purpose computer that has not been so programmed.

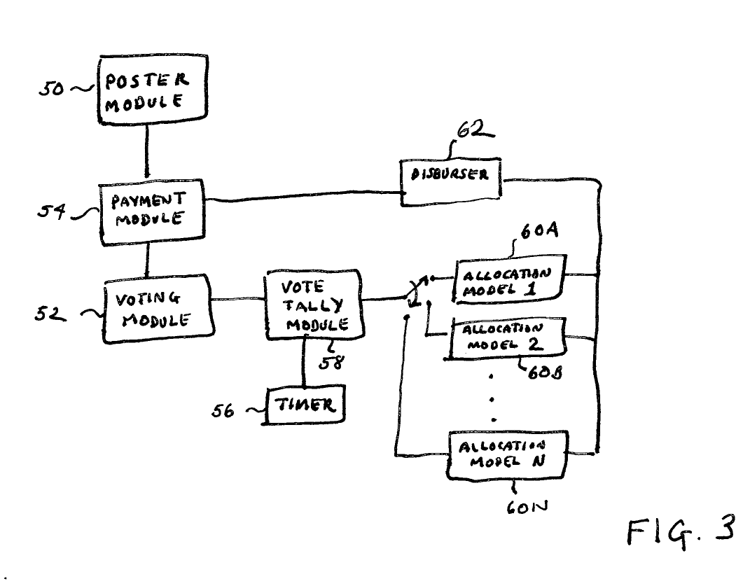

A typical architecture for software for executing the methods described herein is shown in FIG. 3. The architecture features a poster module 50 for receiving postings from posters and adding postings to a web page, and a voting module 52 that receives endorsements from voters 28 and allocates them among the postings 16A-16C on the web page. Both the voting module 52 and the poster module 50 communicate with a payment module 54 that interacts with the payment server 44 to collect posting fees 20A and voter fees from posters and voters respectively.

A timer 56 counts down a voting period during which votes are accepted by the voting module 52. Upon completion of the voting period, the timer 56 causes a vote tally module 58 to count the number of votes drawn by each posting. Upon doing so, the vote tally module 58 causes execution of one of a plurality of allocation models, or pot distribution methods 60A-N. Examples of allocation models 60A-60N include the “winner-take-all” model, the “winner-take-most” model, and models that include voting thresholds.

Having described the invention, and a preferred embodiment thereof, what I claim as new, and secured by Letters Patent is:

1. A computer-implemented method for content endorsement, said method comprising:
receiving, at a server, postings from posters;
receiving, for each posting, a posting fee;
receiving endorsements drawn by said postings;
receiving, for each endorsement, an endorsement fee;
collecting said endorsement fees into a pot;
based on said endorsements, defining a subset of postings; and
allocating at least a portion of said pot to postings in said subset of postings.

2. The method of claim 1, wherein allocating at least a portion of said pot comprises allocating the entire pot among the postings in said subset.

3. The method of claim 1, wherein allocating comprises allocating to a posting on the basis of an extent to which said postings drew endorsements.

4. The method of claim 1, wherein allocating comprises withholding allocation from a posting that drew less than a pre-defined number of endorsements.

5. The method of claim 1, wherein receiving endorsements comprises receiving both positive endorsements and negative endorsements.

6. The method of claim 5, wherein allocating comprises allocating fees to a pot to be distributed to a designated donee organization.

7. The method of claim 6, wherein the fees arise from an endorsement.

8. The method of claim 7, wherein the fees arise from a negative endorsement, and the donee organization is selected by a voter.

9. The method of claim 7, wherein the fees arise from a positive endorsement, and the donee organization is selected by a poster.

10. The method of claim 7, wherein the fees arise from a tip to a poster, and the donee organization is selected by the poster.

11. The method of claim 1, further comprising receiving a tip for distribution to a poster.

12. A content-endorsement system comprising:
endorsing servers;
posting servers;
a content endorsement server for receiving postings from said posting servers and endorsements from said endorsing servers, collecting endorsement fees and posting fees, and following completion of a voting period, tallying votes associated with each of said postings, and distributing endorsement fees.

13. The content-endorsement system of claim 7, wherein said content endorsement server comprises a non-transitory computer-readable medium having encoded thereon instructions for
receiving, at said content-endorsement server, postings from said posting servers;
receiving, for each posting, a posting fee;
receiving endorsements drawn by said postings;
receiving, for each endorsement, an endorsement fee;
collecting said endorsement fees into a pot;
based on said endorsements, defining a subset of postings; and
allocating at least a portion of said pot to postings in said subset of postings.

14. A computer-readable medium having encoded thereon software for implementing content endorsement on a social network, said software including instructions for:
receiving, at a server, postings from posters;
receiving, for each posting, a posting fee;
receiving endorsements drawn by said postings;
receiving, for each endorsement, an endorsement fee;
collecting said endorsement fees into a pot;
based on said endorsements, defining a subset of postings; and
allocating at least a portion of said pot to postings in said subset of postings.
